(19) United States
(12) Patent Application Publication
(10) Pub. No.: US 2019/0345054 A1
(43) Pub. Date: Nov. 14, 2019

(54) PREPARATION METHOD FOR LOW OXYGEN CONTENT SEMICONDUCTOR CORE COMPOSITE MATERIAL OPTICAL FIBRE PREFORM

(71) Applicant: SOUTH CHINA UNIVERSITY OF TECHNOLOGY, Guangdong (CN)

(72) Inventors: Zhongmin YANG, Guangdong (CN); Qi QIAN, Guangdong (CN); Min SUN, Guangdong (CN)

(73) Assignee: SOUTH CHINA UNIVERSITY OF TECHNOLOGY, Guangdong (CN)

(21) Appl. No.: 16/468,287

(22) PCT Filed: Dec. 29, 2017
(86) PCT No.: PCT/CN2017/119615

§ 371 Date: Jun. 11, 2019

(30) Foreign Application Priority Data
Dec. 11, 2016 (CN) 201611134737.8

(51) Int. Cl. C03B 37/012; C03B 37/027; G02B 6/02; G02B 6/036

(52) U.S. Cl. CPC C03B 37/01205; G02B 6/036; G02B 6/02295; C03B 37/027

(57) ABSTRACT

A preparation method for a low oxygen content semiconductor core composite material optical fibre preform comprise: (1) in a nitrogen gas atmosphere glovebox, tightly packing semiconductor core raw material powder into a central hole of a cladding glass tube which is sealed at one end; and (2) performing vacuum pumping on the cladding glass tube packed with the semiconductor core raw material powder, and simultaneously sealing another end of the hot-drawn glass tube to vacuum sealing the semiconductor core raw material powder within the cladding glass tube, so as to obtain the low oxygen content semiconductor core composite material optical fibre preform. The method solves problems in the traditional optical fibre preform preparation methods such as poor packing tightness, high oxygen content in drawn fibre cores, and poor transmission performance in prepared optical fibres.

### TECHNICAL FIELD

The present invention belongs to the field of composite structure optical fibre material technologies, and more particularly, relates to a preparation method for a low oxygen content semiconductor core composite material optical fibre preform.

### BACKGROUND

A semiconductor core composite material optical fibre is a novel optical fibre, which can perfectly combine an excellent optical property of a glass optical fibre with rich optical, electrical and thermal properties of a semiconductor material, has a huge application prospect in the fields of nonlinear optics, sensing, photoelectric detection, infrared power transmission, biomedicine, etc., and is a development direction of optical fibre that has attracted worldwide attention in recent years.

The semiconductor core composite material optical fibre is prepared by firstly preparing an optical fibre preform, and then putting the optical fibre preform into an optical fibre wire-drawing furnace and wire-drawn into an optical fibre. At present, the existing preparation method comprises a powder-in-tube method, a rod-in-tube method, a tube-pumped melt method and a film rolling method. However, the semiconductor in the semiconductor optical fibre preform prepared by the existing methods is easy to adsorb oxygen, thus causing a part of the semiconductor in a drawn optical fibre core to be oxidized. Even if there is inert atmosphere protection in the drawing process to control the oxidation of the optical fibre semiconductor core by the oxygen in the drawing process, the semiconductor material in the optical fibre preform has absorbed a large amount of oxygen, which still leads to a high oxygen content in the finally drawn optical fibre core, i.e., the semiconductor core is oxidized to form an oxidation product that destroys a microstructure of the fibre core, resulting in large infrared light transmission loss of the optical fibre, deterioration of photoelectric performances and other problems. In view of the traditional powder-in-tube method and rod-in-tube method, the present invention provides a method for efficiently preparing a low oxygen content semiconductor core composite material optical fibre preform by synchronous performing vacuum pumping and tube sealing. In a nitrogen glovebox, a vacuum-packed semiconductor core material is taken out and filled into a cladding glass tube which has been hot-drawn and sealed at one end. A vacuum pump is used to vacuum the cladding tube, and meanwhile, an unsealed end of the cladding tube is hot-drawn to seal the core material into the cladding tube to prepare the optical fibre preform. With the help of a glass optical fibre wire-drawing method, the preform is put into the optical fibre wire-drawing furnace and is heated and wire-drawn. The method can be used for preparing the low oxygen content semiconductor core composite material optical fibre preform, which effectively solves problems of the traditional semiconductor core glass cladding preforms such as oxygen absorption of core material, poor packing tightness, high oxygen content in drawn fibre cores, and poor infrared transmission performance in optical fibres and so on, and the prepared low oxygen content semiconductor core composite material optical fibre preform is widely applicable and has a controllable size. In addition, the preparation efficiency of the optical fibre is high.

### SUMMARY

An object of the present invention is to provide a preparation method for a low oxygen content semiconductor core composite material optical fibre preform. The method adopts a vacuum pumping and sealing tube synchronization method, that is, by means of a vacuum-sealed tube in a glovebox, to efficiently prepare the low oxygen content semiconductor core composite material optical fibre preform.

The object of the present invention is achieved by the following technical solutions.

A preparation method for a low oxygen content semiconductor core composite material optical fibre preform, comprising the following steps of:

(1) in a nitrogen gas atmosphere glovebox, tightly packing a semiconductor core raw material powder into a central hole of a cladding glass tube which is sealed at one end; and

(2) performing vacuum pumping on the cladding glass tube packed with the semiconductor core raw material powder, and simultaneously sealing another end of the glass tube by hot drawing to vacuum sealing the semiconductor core raw material powder within the cladding glass tube, so as to obtain the low oxygen content semiconductor core composite material optical fibre preform.

Further, in the step (1), the semiconductor core material comprises one or more of Al, Ga, In, Si, Ge, Sn, Pb, P, As, Sb, Bi, S, Se and Te.

More further, in the step (1), the semiconductor core raw material powder is stored in a vacuum package before use.

Further, in the step (1), the cladding glass tube is any oxide glass, comprising a borosilicate glass tube.

Further, in the step (1), the cladding glass tube which is sealed at one end is obtained by the following processing: using a butane flame to heat and soften the cladding glass tube, and sealing one end of the cladding glass tube by hot drawing, and then ultrasonically cleaning the cladding glass tube with 10 vol % dilute hydrochloric acid and absolute ethanol for 10 minutes sequentially.

More further, an ultrasonic frequency is 80 Hz and an ultrasonic power is 300 W.

Further, in the step (1), a glass softening temperature of the cladding glass tube is higher than a melting temperature of the semiconductor core raw material powder.

Further, in the step (2), the vacuum pumping refers to performing the vacuum pumping to a pressure ranging from 10⁻⁶ to 100 Pa.

Further, the prepared low oxygen content semiconductor core composite material optical fibre preform is wire-drawn to obtain a low oxygen content semiconductor core composite material optical fibre, and an oxygen content of the obtained low oxygen content semiconductor core composite material optical fibre is less than 5 wt %.

Compared with the prior art, the present invention has the following advantages and beneficial effects.

(1) The present invention solves the problems of the traditional preparation method for a composite material optical fibre preform such as high oxygen content in the fibre core inside the optical fibre, destruction of a microstructure of the fibre core by oxydates, poor packing tightness, high oxygen content in the drawn fibre core and poor transmission performance of the prepared optical fibre caused by the fact that the oxygen absorbed in the core material and the oxygen in the cladding layer are not removed.

(2) The low oxygen content semiconductor core composite material optical fibre preform prepared by the method of the present invention is widely applicable and has a controllable size. In addition, the preparation efficiency of the optical fibre is high and the preparation costs are low.

(3) The low oxygen content semiconductor core composite material optical fibre preform prepared by the method of the present invention can be wire-drawn under the condition of no atmosphere protection to prepare a low oxygen content semiconductor core composite material optical fibre, which has a high transmission performance, and is expected to be applied to micro devices or wearable equipment of multifunctional optical fibres such as infrared light transmission, nonlinear optics, metamaterials, solar cells, thermoelectric conversion and the like.

### BRIEF DESCRIPTION OF THE DRAWINGS

FIG. 1 is an X-ray diffraction comparison diagram of an In—Se powder raw material, an ordinary In—Se semiconductor core composite material optical fibre powder and a low oxygen content In—Se semiconductor core composite material optical fibre powder in an embodiment 1;

FIG. 2a is an elemental line scanning diagram of a polished end face of the ordinary In—Se semiconductor core composite material optical fibre in the embodiment 1;

FIG. 2b is an elemental line scanning diagram of a polished end face of the low oxygen content In—Se semiconductor core composite material optical fibre in the embodiment 1; and

FIG. 3 is an electron probe spectrometer surface scanning diagram of the polished end face of the low oxygen content In—Se semiconductor core composite material optical fibre in the embodiment 1.

### DETAILED DESCRIPTION

In order to better understand the present invention, the contents of the present invention will be further illustrated below with reference to the embodiments, but the embodiments of the present invention are not limited thereto, and the process parameters not specifically described may be referred to the conventional techniques.

### Embodiment 1

Preparation of an optical fibre preform having In—Se semiconductor core composite material and an optical fibre having In—Se semiconductor core composite material:

(1) processing and cleaning of cladding glass tube: two borosilicate glass tubes with an inner diameter of 3 mm, an outer diameter of 8 mm and a length of 20 cm were used; an original length of a blanking head was 3 cm, and the two glass tubes were heated by aligning tube walls with a butane flamer; when the borosilicate glass tube was softened, a lower end of the glass tube was sealed by hot drawing; the borosilicate glass tube with the lower end sealed was cleaned in an ultrasonic cleaner for 10 minutes using 10 vol % diluted hydrochloric acid and high-purity absolute ethanol respectively at an ultrasonic frequency of 80 Hz, and an ultrasonic power of 300 W;

(2) assembling of an ordinary optical fibre preform: in the atmosphere, In powder (4N, a melting point of 156.6° C.) raw material and Se powder (4N, a melting point of 221° C.) raw material were taken out from a vacuum package, and the precursor powder was uniformly mixed according to an atomic ratio that In:Se=4:3; the cladding glass tube with the lower end sealed was vertically placed with an opening facing upward, and the mixed powder was tightly packed into the central hole of the cladding glass tube cleaned by the step (1), then the upper opening of the cladding glass tube was sealed with clay and water glass, and marked as an ordinary optical fibre preform;

(3) packaging of low oxygen content optical fibre preform: in a nitrogen gas atmosphere glovebox, the In powder (4N) raw material and Se powder (4N) raw material were taken out from a vacuum package, and the precursor powder was uniformly mixed according to an atomic ratio that In:Se=4:3; the cladding glass tube was vertically placed with the opening facing upward, and the mixed powder was tightly packed into the central hole of the cladding glass tube cleaned by the step (1); a rubber hose of a mechanical vacuum pump (with an ultimate vacuum pressure of 10⁻² Pa) was butted against the cladding glass tube, and a butane flame was aligned with an upper end of the glass tube to hot-draw the upper end of the cladding glass tube while performing vacuum pumping on the cladding glass tube; an original length of a feeding head was 3 cm, and the core material was vacuum-sealed inside the cladding glass tube to prepare an optical fibre preform, and mark the prepared optical fibre preform as a low oxygen content optical fibre preform; and

(4) wire-drawing of optical fibre: the ordinary optical fibre preform and the low oxygen content optical fibre preform assembled in the step (3) were sequentially placed on a commercial wire-drawing tower; under the argon atmosphere protection, a middle portion of the ordinary optical fibre preform was heated for wire-drawing at a wire-drawing temperature of 900° C.; and in a case of no atmosphere protection, the low oxygen content optical fibre preform was directly heated for wire-drawing at a wire-drawing temperature of 900° C. .

Finally, an ordinary In—Se semiconductor core composite material optical fibre and a low oxygen content In—Se semiconductor core composite material optical fibre was obtained, wherein the optical fibre has a diameter of 250 μm and a continuous length of more than 1 m.

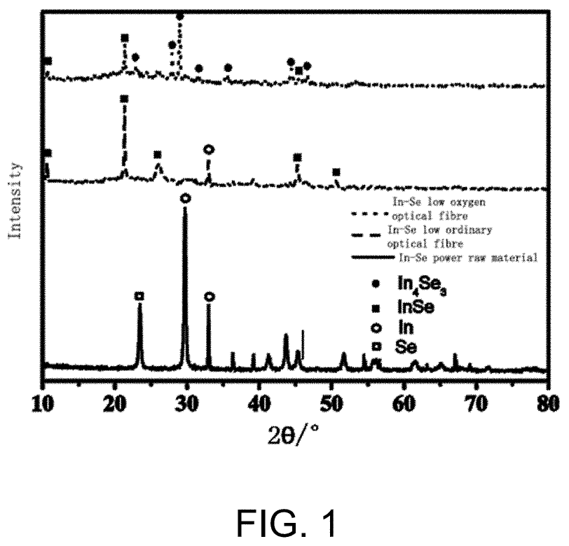

FIG. 1 is an X-ray diffraction comparison diagram of an In—Se (an atomic ratio is that In:Se=4:3) powder material, an ordinary In—Se semiconductor core composite material optical fibre powder and an low oxygen content In—Se semiconductor core composite fibre powder. It can be seen from FIG. 1 that the ordinary In—Se semiconductor core composite material optical fibre contains a large amount of InSe compounds and a small amount of In elemental crystals, while the low oxygen content In—Se semiconductor core composite material optical fibre contains a large amount of In₄Se₃ and a small amount of InSe compound crystals, indicating that a combination reaction between In and Se in the low oxygen content In—Se semiconductor core composite material optical fibre is more complete.

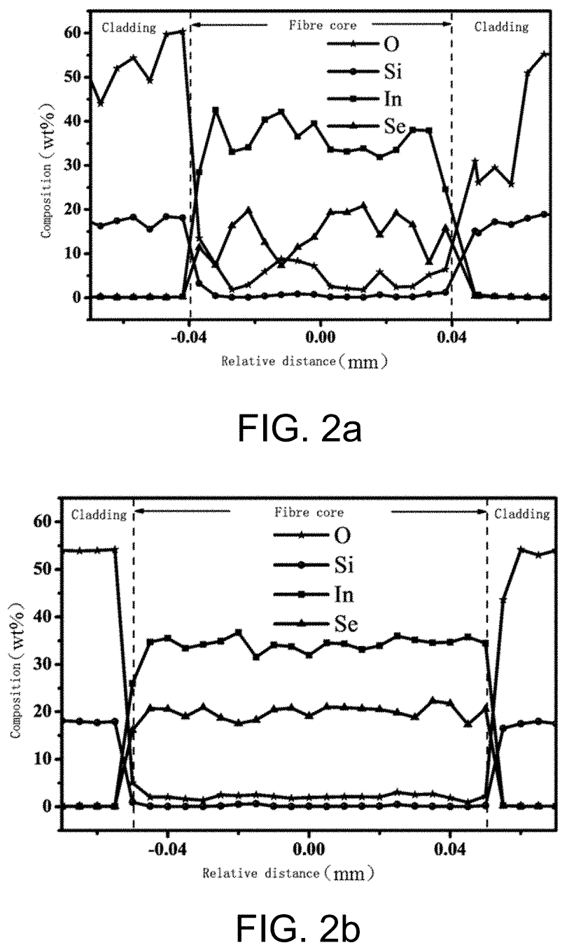

FIG. 2a and FIG. 2b are elemental line scanning diagrams of polished end faces of the ordinary In—Se semiconductor core composite material optical fibre and the low oxygen content In—Se semiconductor core composite material optical fibre respectively. It can be seen from FIG. 2a and FIG. 2b that the oxygen content of the low oxygen content In—Se semiconductor core composite material optical fibre is less than 5 wt %, and the element distribution thereof is stable relative to that of the ordinary In—Se semiconductor core composite material optical fibre.

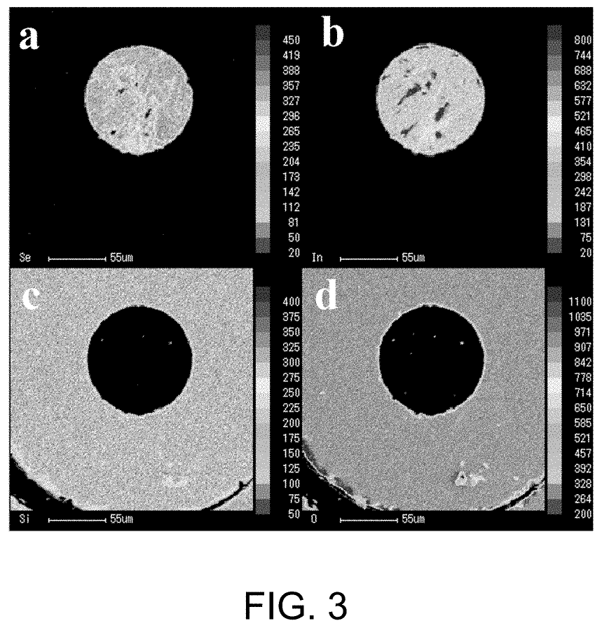

FIG. 3 is an electron probe spectrometer surface scanning diagram of the polished end face of the low oxygen content In—Se semiconductor core composite material optical fibre (O, Si, In, Se). It can be seen from FIG. 3 that the low oxygen content In—Se semiconductor core composite material optical fibre has a small amount of segregation of element In, but no core cracks, and also has an excellent circularity, indicating that continuous low oxygen content In—Se core composite material optical fibre is obtained.

### Embodiment 2

Preparation of a low oxygen content Sn—Se semiconductor core composite material optical fibre preform and a low oxygen content Sn—Se semiconductor core composite material optical fibre:

The preparation method is the same as that of the embodiment 1 for preparing the low oxygen content In—Se semiconductor core composite material optical fibre, but differs in that: the semiconductor core raw material powder was selected from tin powder (Sn, 4N, a melting point of 118.7° C.) and selenium powder (Se, 4N, a melting point of 221° C.); for the borosilicate glass tube sealed at the lower end and having a length of 15 cm, an inner diameter of 3 mm, and an outer diameter of 8 mm, the packing powder was uniformly mixed according to an atomic ratio that Sn:Se=1:1, and tightly packed into the center hole of the cladding glass tube.

The prepared low oxygen content Sn—Se semiconductor core composite material optical fibre has a diameter of 200 μm.

A combination reaction between Sn and Se in the low oxygen content Sn—Se semiconductor core composite material optical fibre is relatively complete. The low oxygen content Sn—Se semiconductor core composite material optical fibre has a oxygen content less than 5 wt %, and a fibre core which is a mixture of SnSe and SnSe₂ with excellent high temperature thermal sensitivity, and is expected to be applied to temperature sensing.

### Embodiment 3

Preparation of a low oxygen content Bi—Te semiconductor core composite material optical fibre preform and a low oxygen content Bi—Te semiconductor core composite material optical fibre:

The preparation method is the same as that of the embodiment 1 for preparing the low oxygen content In—Se semiconductor core composite material optical fibre, but differs in that: the semiconductor core raw material powder was selected from a commercial P-type Bi—Te alloy bar, and was machined into a thin alloy bar with a length of 10 cm and a diameter of 3 mm, and a melting point of 585° C. about; the borosilicate glass tube sealed at the lower end has a length of 15 cm, an inner diameter of 3 mm, and an outer diameter of 8 mm; the machined thin alloy bar was tightly packed into the center hole of the cladding glass tube. The prepared low oxygen content Bi—Te semiconductor core composite material optical fibre has a diameter of 200 μm. A combination reaction between Bi and Te in the low oxygen content Bi—Te semiconductor core composite material optical fibre is relatively complete. The low oxygen content Bi—Te semiconductor core composite material optical fibre has an oxygen content less than 5 wt %, and stable element distribution. A fibre core has excellent low-temperature thermoelectric properties.

The optical fibre is expected to be applied to wearable low-temperature thermoelectric material power generation devices.

1. A preparation method for a low oxygen content semiconductor core composite material optical fibre preform, wherein the preparation method comprises the following steps of:
(1) in a nitrogen gas atmosphere glovebox, tightly packing a semiconductor core raw material powder into a central hole of a cladding glass tube which is sealed at one end; and
(2) performing a vacuum pumping on the cladding glass tube packed with the semiconductor core raw material powder, and simultaneously sealing another end of the glass tube by hot drawing to vacuum sealing the semiconductor core raw material powder within the cladding glass tube, so as to obtain the low oxygen content semiconductor core composite material optical fibre preform.

2. The preparation method for the low oxygen content semiconductor core composite material optical fibre preform according to claim 1, wherein, in the step (1), the semiconductor core material comprises one or more of Al, Ga, In, Si, Ge, Sn, Pb, P, As, Sb, Bi, S, Se and Te.

3. The preparation method for the low oxygen content semiconductor core composite material optical fibre preform according to claim 1, wherein, in the step (1), the cladding glass tube is any oxide glass, comprising a borosilicate glass tube.

4. The preparation method for the low oxygen content semiconductor core composite material optical fibre preform according to claim 1, wherein, in the step (1), a glass softening temperature of the cladding glass tube is higher than a melting temperature of the semiconductor core.

5. The preparation method for the low oxygen content semiconductor core composite material optical fibre preform according to claim 1, wherein, in the step (2), a vacuum pressure for the vacuum pumping ranges from 10⁻⁶ Pa to 100 kPa.

6. The preparation method for the low oxygen content semiconductor core composite material optical fibre preform according to claim 1, wherein the obtained optical fibre preform is wire-drawn to obtain a low oxygen content semiconductor core composite material optical fibre, and an oxygen content in the obtained low oxygen content semiconductor core composite material optical fibre is less than 5 wt %.
